(19) United States
(12) Patent Application Publication
(10) Pub. No.: US 2023/0194049 A1
(43) Pub. Date: Jun. 22, 2023

(54) Pressure Tunnel

(71) Applicant: Shahriar Eftekharzadeh, Torrance, CA (US)

(72) Inventor: Shahriar Eftekharzadeh, Torrance, CA (US)

(21) Appl. No.: 17/240,011

(22) Filed: Apr. 26, 2021

(51) Int. Cl. F17C 1/00; B65G 5/00

(52) U.S. Cl. CPC F17C 1/007; B65G 5/00; F17C 2223/035; F17C 2270/016; F17C 2227/0135; F17C 2221/013; F17C 2221/033; F17C 2201/0119; F17C 2201/052

(57) ABSTRACT

An apparatus for storing large quantities of compressed gas at high pressure underground.

### FIELD OF THE INVENTION

The present invention is in the field of devices for storing compressed gas. More specifically, the present invention discloses a new apparatus for storing large quantities of compressed gas at high pressure underground.

### BACKGROUND OF THE INVENTION

The ability to store large quantities of compressed gas such as air, natural gas, and carbon dioxide is instrumental in transitioning to renewable energies and to combating climate change. Using natural gas as transition fuel, as well as the feasibility of compressed air energy storage technologies, require sizeable storage facilities that can safely withstand large internal pressures. In addition, a compressed gas storage facility can provide a viable solution for sequestering carbon dioxide if the size of the storage facility is sufficiently large to handle the quantity of carbon dioxide involved at a given location.

Currently, the only really viable means of storing large quantities of compressed gas are natural underground caverns, cavities, and voids that have formed in various geological formations over time. These are particularly prevalent in formations bearing fossil fuel, which become available for compressed gas storage once the crude oil has been extracted. Others are formed in porous limestone over time by the action of acidic groundwater or underground rivers that dissolve away the limestone. However, these opportunities are highly location-specific and are hence not widely available where needed.

There are two attributes of natural underground cavities that make them suitable for large-scale compressed gas storage. One is the sheer size of the cavities, which are very large, and the other is their ability to withstand large internal pressure because of the structural strength of the confining ground formation and the weight of the soils above. These conditions are unique to the underground environment and cannot be created at scale aboveground.

Therefore, there is a need to create underground voids with sizable volume that can withstand large internal pressure to store compressed gas. Such an ability would greatly facilitate the transition to renewable energies and provide a means for sequestering carbon dioxide, which is urgently needed to combat climate change.

### SUMMARY OF THE INVENTION

The present invention provides a solution for the above stated need with an underground tunnel designed and purposely built to provide a certain volume of void space that can withstand a target level of internal pressure. These are the main requirements that determine the dimensions of the tunnel and its location and alignment in a given geological formation underground.

The present invention is essentially a certain length of a tunnel with circular cross section having a design diameter to provide a desired volume of void at a particular location underground. It may be bored substantially level at a design depth within a particular geological formation and depth below ground, which possesses the necessary geotechnical properties and structural strength to enable the tunnel to withstand the design internal pressure that results from storing compressed gas inside. Alternatively, it may be bored with variable slope and alignment to be located within target geological layers underground.

The design internal pressure depends on the purpose of the compressed gas tunnel. For compressed air energy storage, it is desired for the tunnel to have as high a pressure rating a possible since this maximizes its energy storage capacity. For natural gas and carbon dioxide storage consideration must be given to the liquid-gas equilibrium per their respective phase diagrams in order to determine the maximum design pressure for the prevailing temperatures.

The tunnel of the present invention may be bored underground using conventional tunnel boring techniques and technologies, as well as future improved techniques. Conventional techniques use a launch shaft to lower and locate the tunnel boring machine down to the invert level of the tunnel, plus a receive shaft at the other end to retrieve the tunnel boring machine. In addition, the plan alignment of the present invention can be a closed loop circle such that it is possible to use a single shaft for both launching and receiving the tunnel boring machine where a circular plan alignment is used. For multiple tunnels, it is possible to use the same launch and receive shafts with tunnels vertically stacked with certain vertical spacing, which may or may not be connected. The tunnel of the present invention may also be constructed using the recently developed surface-launch and receive technologies for the tunnel boring machine, which eliminates the need for a shaft. However, using this technology would require adequately plugging the tunnel with structurally sound material at both ends down to the design geological formation such that the internal pressure rating of the tunnel is not compromised.

The key requirement for the tunnel of the present invention is to locate it at the correct depth underground where internal pressure forces in the tunnel exerted on its perimeter are adequately and safely resisted by the confining geological formation. The correct location for the required internal pressure rating may be determined by conducting geotechnical investigations that reveal the mechanical properties of the underground formations and using them in calculation procedures disclosed herein to determine the tunnel pressure rating. Another requirement is air-tightness, which may be provided by internal lining with a suitable gas-impermeable membrane, as necessary.

The tunnel of the present invention may be used for compressed air energy storage, for both adiabatic and isothermal processes. In particular, the long slender shape of the tunnel of the present invention has similar thermodynamic heat exchange properties with the confining ground as the vertical shaft compressed air storage vessel disclosed in U.S. Pat. No. 9,787,161 B2, which is incorporated in its entirety herein. This makes the present invention particularly suitable for utilization for isothermal compressed air energy storage in the form of a large hydraulic accumulator, disclosed herein as one embodiment of the present invention. In this embodiment, the compressed gas tunnel may be filled with compressed air up to a certain pressure to contain a design mass of air. Water may then be pumped into the compressed gas tunnel to further compress the air inside and thus store energy. The process may then be later reversed to recover the stored energy. The slow rates of air compression and expansion provide adequate time for heat exchange between the tunnel and surrounding ground to keep the temperature substantially the same resulting in an isothermal process.

The water needed for the process may be stored at atmospheric pressure housed either at ground level or in a conventional tunnel underground. In the case of the latter, consideration must be given to the net positive suction head required at the water pump, meaning that the elevation difference between the pump and the water tunnel at atmospheric pressure cannot exceed the water vapor pressure. This limitation may be overcome by also pressurizing the water storage tunnel to provide adequate back pressure for the pump at the desired pump elevation. This will reduce the energy storage capacity of the pressurized gas tunnel, but will not result in any energy loss over the cycle.

It is an object of this invention to provide a practical facility to store large quantities of compressed gas underground.

It is an object of this invention to provide a facility for compressed air energy storage and recovery technologies, particularly for an isothermal compressed air energy storage facility in the form of a hydraulic accumulator.

It is an object of this invention to provide a facility that can safely and permanently sequester large quantities of carbon dioxide.

It is an object of this invention to provide improved elements and arrangements by apparatus for the purposes described thereof, which is comparable in cost with existing systems, dependable, and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of the compressed gas tunnel of the present invention constructed underground using conventional launch and receive shafts.

FIG. 2 is a cut profile section view of one end of the tunnel of the present invention showing the various elements that comprise the invention.

FIG. 3 is a cut cross section view of one end of the tunnel of the present invention showing the various elements that comprise the invention.

FIG. 4 is an embodiment of the present invention in circular plan form.

FIG. 5 is a cross section diagram of the present invention showing the forces and equations that may be used to establish the internal pressure rating of the tunnel at a given depth below ground surface.

FIG. 6 is a graph showing how the tunnel internal pressure rating varies with tunnel depth below surface for different strength soils.

FIG. 7 is one embodiment of the present invention used for adiabatic compressed air energy storage.

FIG. 8 is one embodiment of the present invention used for isothermal compressed gas energy storage in the form of a hydraulic accumulator.

FIG. 9 is the same embodiment of the present invention as in FIG. 8 with the ground formation not shown.

FIG. 10 is a cut profile section of the embodiment of the present invention in FIG. 9 during energy storage.

FIG. 11 is a cut profile section of the embodiment of the present invention in FIG. 9 during energy recovery.

### DETAILED DESCRIPTION

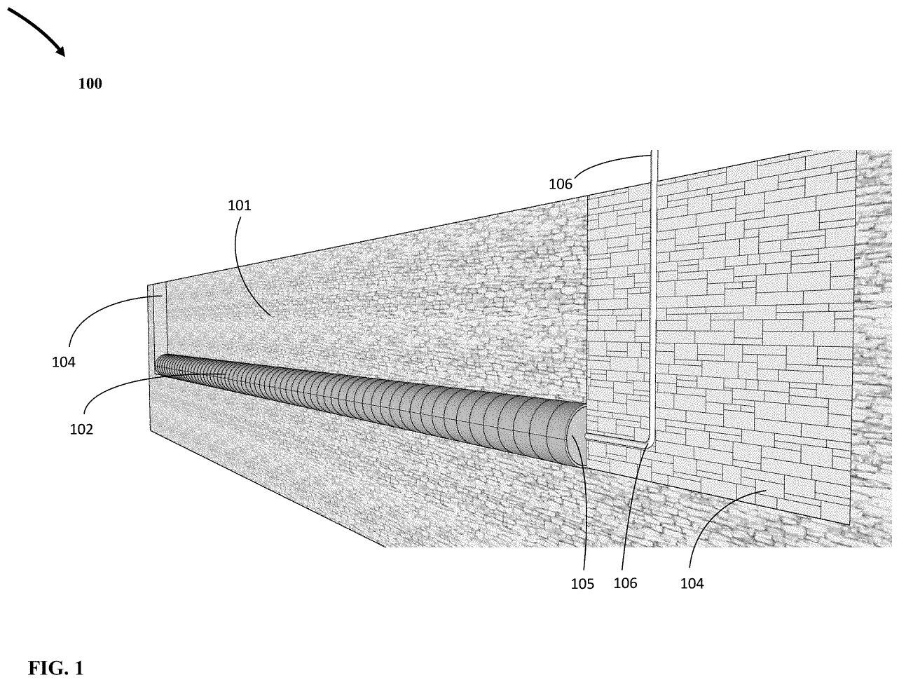

Referring to FIG. 1, there is shown a perspective view of the compressed gas tunnel 102 of the present invention 100 constructed underground 101 using conventional launch and receive shafts 104, which have been backfilled and compacted to original ground level. Tunnel 102 is fitted with plugs 105 at both ends to form an entirely enclosed void space underground. There is an air conduit 106 disposed to establish pneumatic communication between the interior of tunnel 102 and mechanical equipment (not shown). In order to increase storage capacity multiple tunnels 102, vertically separated by appropriate distance, may be bored using same launch and receive shafts 104, to result in a multi-story compressed gas tunnel 102 facility. The individual tunnels of such a multi-story facility may be connected with conduit.

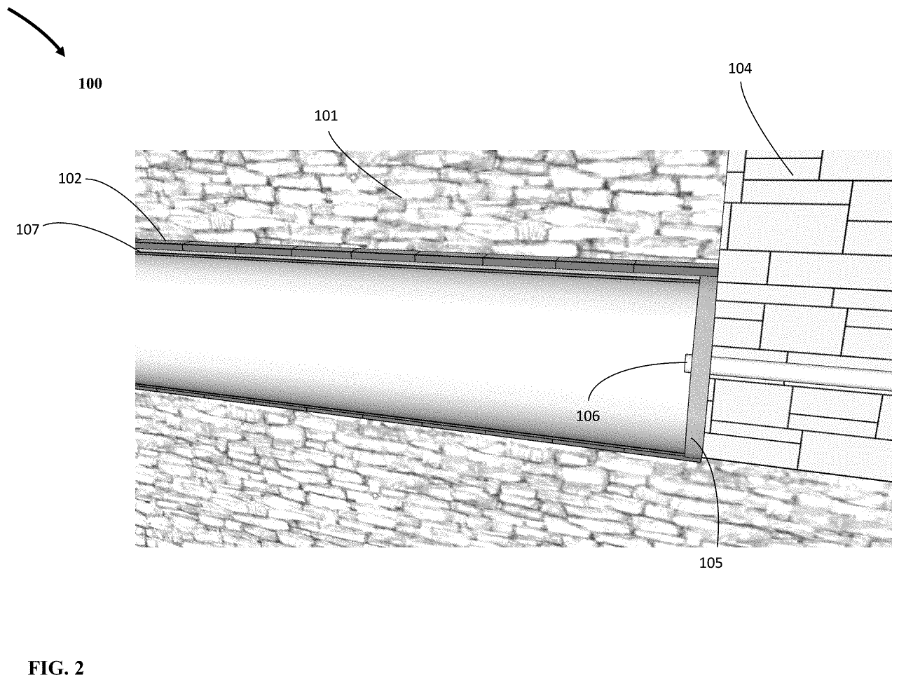

FIG. 2 is a cut profile section view of one end of the tunnel 102 of the present invention underground 101. It shows interior of tunnel 102 lined with gas-impermeable liner 107 as well as plug 105 firmly fitted to seal the end. Air conduit 106 penetrates plug 105 to establish pneumatic communication with mechanical equipment (not shown). Tunnel boring machine shaft 104 is fully backfilled and compacted to provide structural support for plug 105 to resist internal pressure forces of tunnel 102.

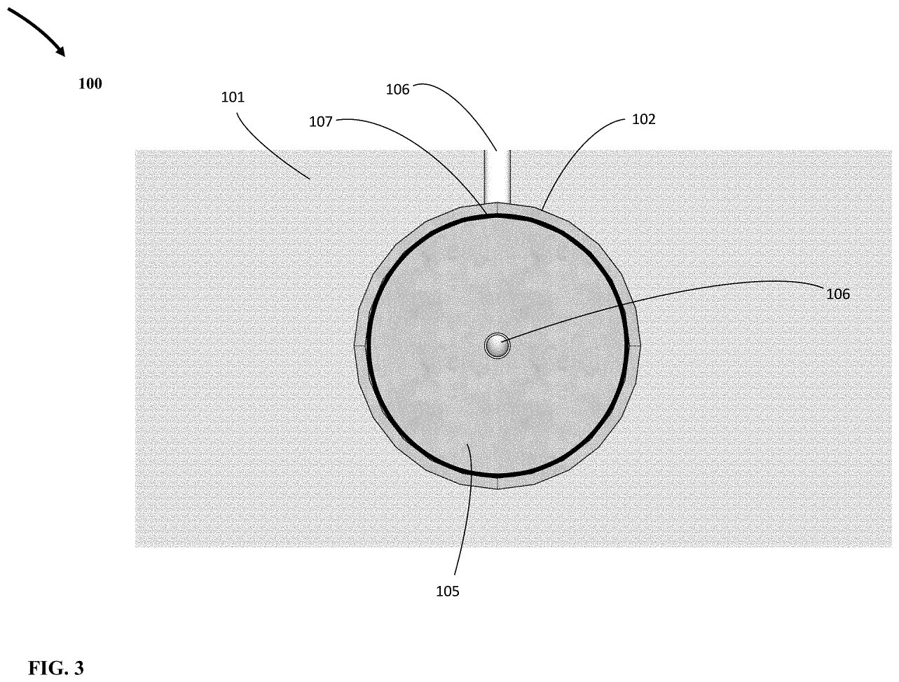

FIG. 3 is a cut cross section view of one end of the tunnel of the present invention underground 101. It shows interior of tunnel 102 lined with gas-impermeable liner 107 as well as plug 105 firmly fitted to seal the end. Air conduit 106 penetrates plug 105 to establish pneumatic communication with mechanical equipment (not shown).

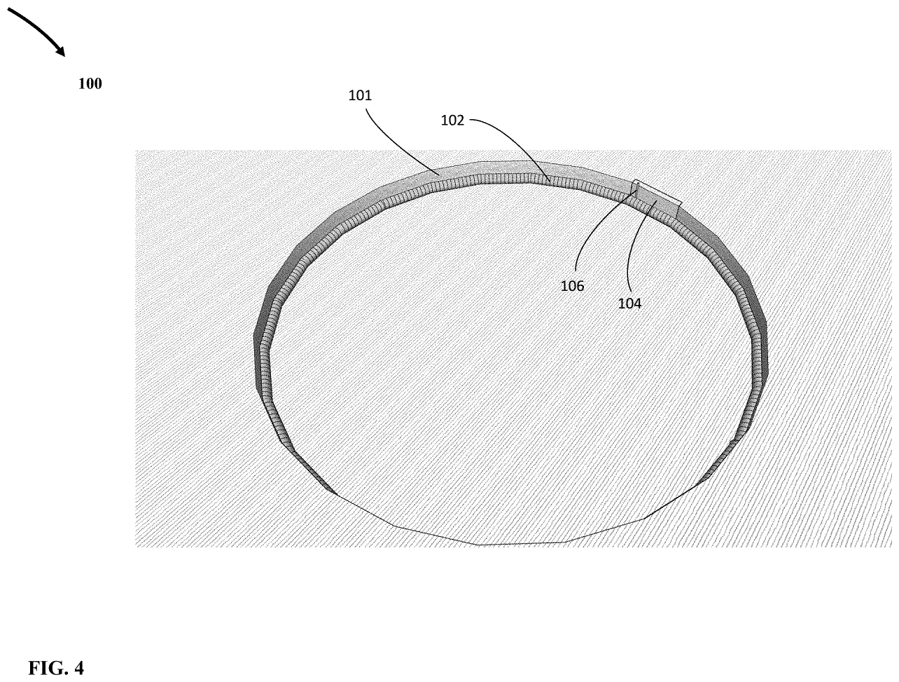

FIG. 4 is an embodiment of the present invention 100 in circular plan form. Alignment of tunnel 102 is circular and configured such that launch shaft 104 is situated on the circumference of the alignment. This results in the tunnel boring machine to exit at the opposite face of the shaft, thus eliminating the need for a separate receive shaft to retrieve the boring machine. In order to increase storage capacity, multiple tunnels 102, vertically separated by appropriate distance, may be bored using same launch/receive shaft 104, to result in a multi-story compressed gas tunnel 102 facility. The individual tunnels of such a multi-story facility may be connected with conduit. One option is to bore a continuous loop alignment in the form of a spiral.

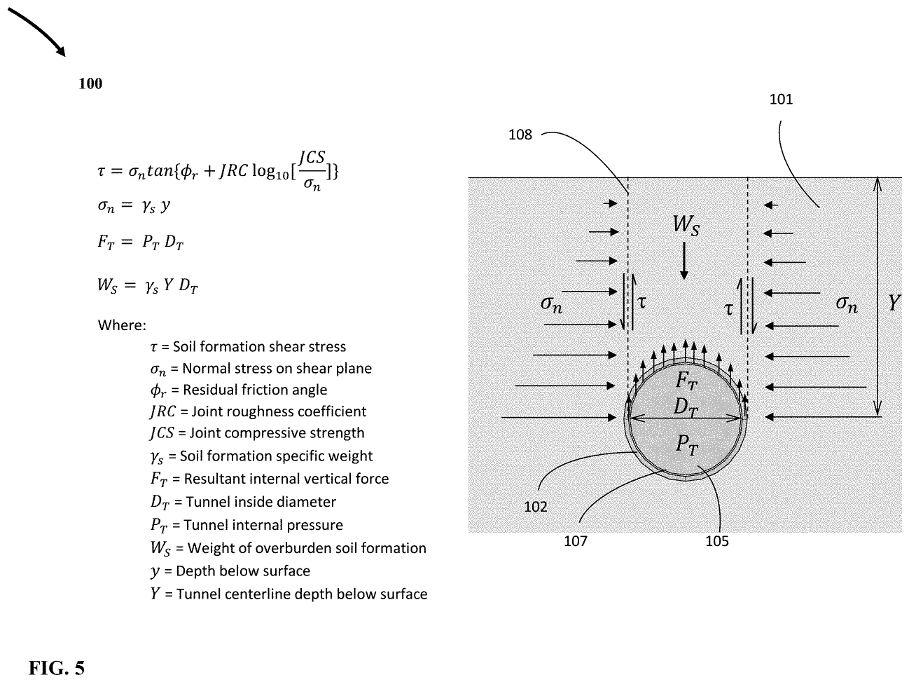

FIG. 5 is a cross section diagram of the present invention showing the forces and equations that may be used to establish the internal pressure rating of the tunnel at a given depth below ground surface. While tunnel 102 is fully confined all around with ground formation 101, it is weakest in the vertical direction, directly above where the resultant vertical force upward, F_{T}, from pressure inside tunnel 102 is resisted by tangential shear stress, τ, along opposite facing shear planes 108, plus the weight of the soil formation W_{S} directly above. The equations shown for calculating tangential shear as a function of soil mechanical properties are from present art in the field of rock mechanics. The purpose is to determine the depth below ground, Y, that one needs to bore in order to safely pressurize tunnel 102 of the present invention to the required pressure P_{T}.

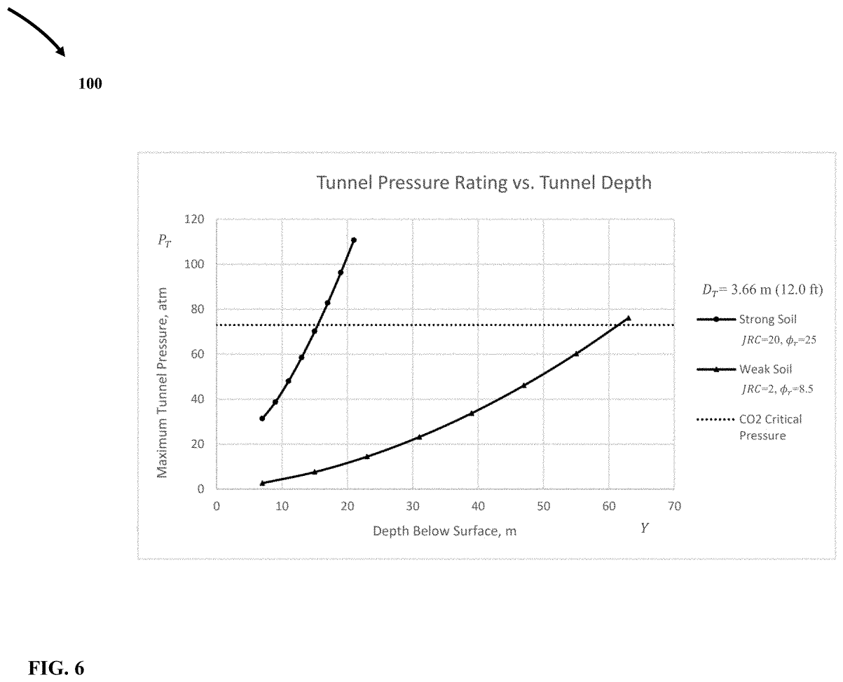

FIG. 6 is a graph of calculation results using balance of forces in the vertical direction. It shows how the tunnel internal pressure rating P_{T} varies with tunnel depth below surface, Y, for different strength soils based on the equations shown in FIG. 5. The results show that the pressure rating of the tunnel of the present invention 100 is highly dependent of the mechanical properties of the soil that affect shear strength, namely the Joint Roughness Coefficient, JRC, and the Residual Friction Angle, ϕᵣ. Also shown is the 73 atmosphere critical pressure value for carbon dioxide, CO2, which is the highest pressure at which carbon dioxide can be pressurized to while still remaining a gas. Any higher pressure would change the state of carbon dioxide to liquid. The critical pressure is the upper limit of pressure for using the present invention 100 for carbon dioxide sequestration. Based on the results, in a “strong soil” formation, a tunnel with 3.66 m (12-ft) internal diameter will need to be located only about 17 meter (55 ft) below ground to withstand an internal pressure of 73 atmospheres. However, in a “weak formation” the tunnel would have to be lowered down to about 62 meters (203 ft) below ground to withstand 73 atmosphere internal pressure. This underscores the cruciality of correctly knowing the mechanical properties of the soil formation to safely locate the pressurized gas tunnel 100 that is the present invention.

The corresponding mass of CO2 stored can be determined from gas law equations that equate the product of gas pressure and volume to the product of number of moles, universal gas constant, and temperature. Accordingly, one mile length of the pressurized gas tunnel of the present invention, which furnishes a void volume of 16,914 m³ (596,850 ft³), can store about 39,500 metric tons of carbon dioxide at 70 atmospheres. This is equivalent to the average annual carbon dioxide emissions of about 8600 average size internal combustion engine cars, which is significant. Assuming a total cost of $10.0 Million per mile for the tunnel of the present invention, the corresponding unit cost of CO2 sequestration is about $250 per metric ton, which is significantly less than the current cost of underground CO2 sequestration using present art of about $400 per metric ton.

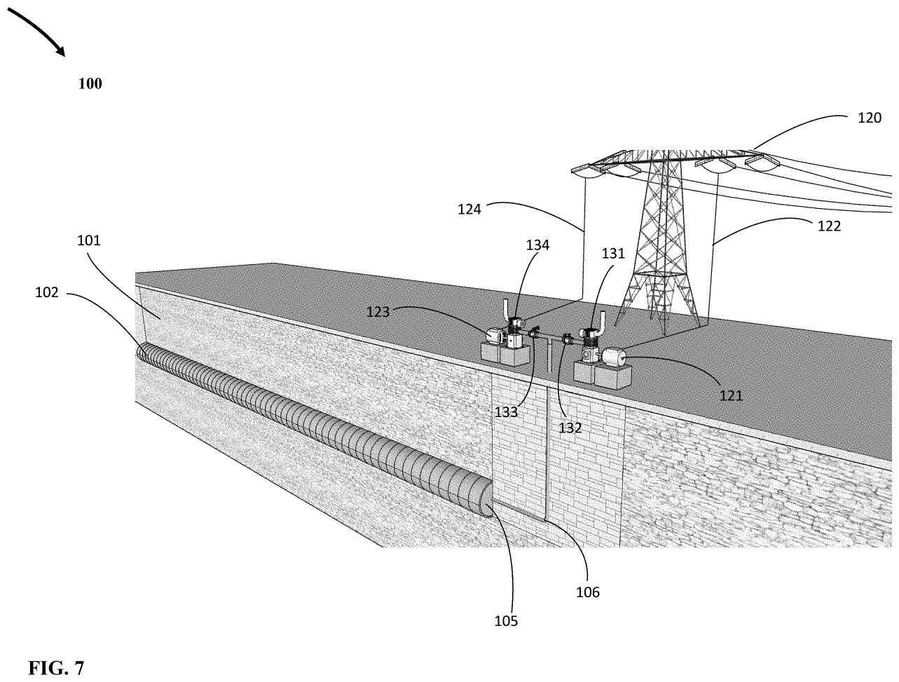

FIG. 7 is one embodiment of the present invention 100 utilized for adiabatic compressed air energy storage and recovery. During energy storage, electric power from grid 120 drives electric motor 121 via electrical conduit 122 that runs air compressor 131, which is pneumatically connected to tunnel 102 via air conduit 106 by having inlet air valve 132 open and outlet air valve 133 closed. Air compression process continues until pressure in tunnel 102 reaches maximum design value or time allocated for energy storage is over, whichever is first. During energy recovery, air inlet valve 132 is closed and air outlet valve 133 is opened for pressurized air in tunnel 102 to drive air expander 134 that runs electric generator 123 to feed electrical power to grid 120 via electrical conduit 124. Except for the compressed air reservoir, which is the compressed gas tunnel 102 of the of the present invention 100, the process described and shown in FIG. 7 is standard adiabatic compressed air energy storage and recovery.

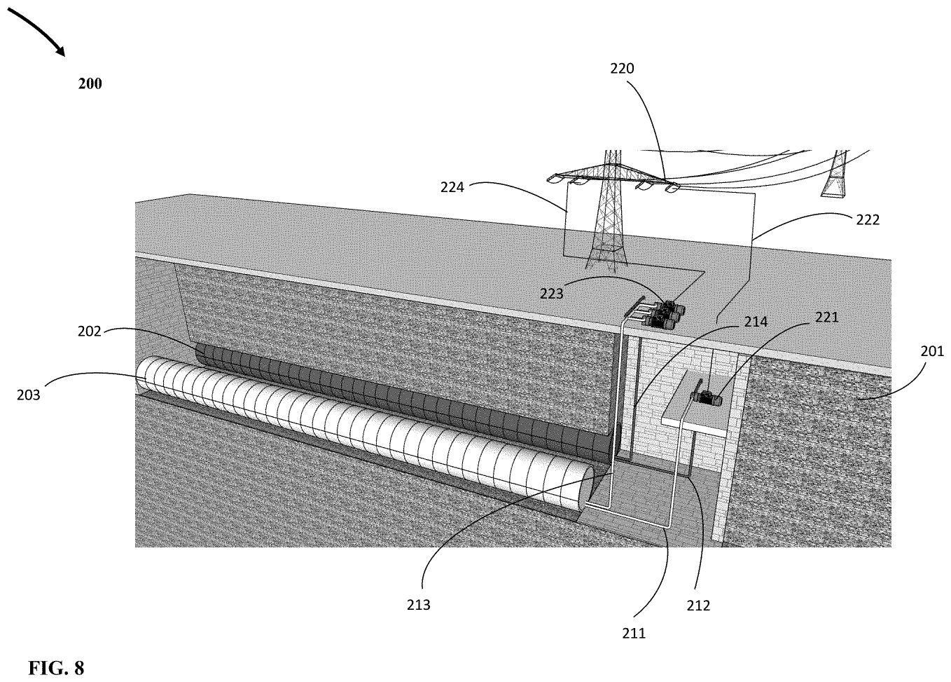

FIG. 8 is another embodiment of the present invention 200 used for isothermal compressed gas energy storage and recovery in the form of a hydraulic accumulator. Low-pressure tunnel 203 underground 101 is disposed for water storage and high-pressure tunnel 202 underground 101 is disposed for compressed gas storage. Low-pressure water conduit 211 connects interior of low-pressure tunnel 203 to electric water pump 221, while high-pressure water conduit 212 connects electric water pump 221 to high-pressure tunnel 202. Similarly, high-pressure water conduit 214 connects high-pressure tunnel 202 to hydraulic generators 213, while low-pressure water conduit 213 connects hydraulic generators 213 to low-pressure tunnel 203. High-pressure water conduit 214 and high-pressure water conduit 212 are both fitted with internal check valves that prevent flow in the opposite direction. Water pump 221 is supplied with electrical power from electrical grid 220 via electrical conduit 222, while hydraulic generators 213 are for supplying power to electrical grid 220 via electrical conduit 224.

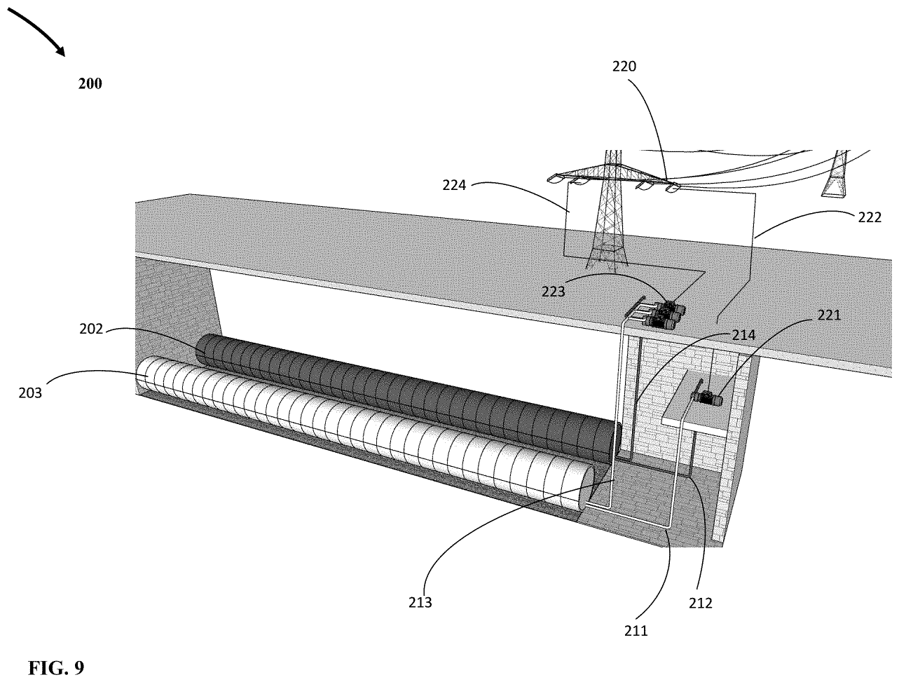

FIG. 9 is the same embodiment of the present invention 200 as in FIG. 8 with the ground formation 101 not shown. The purpose of FIG. 9 is to better show low-pressure tunnel 203 and high-pressure tunnel 202. All connectivities are as described in previous paragraph.

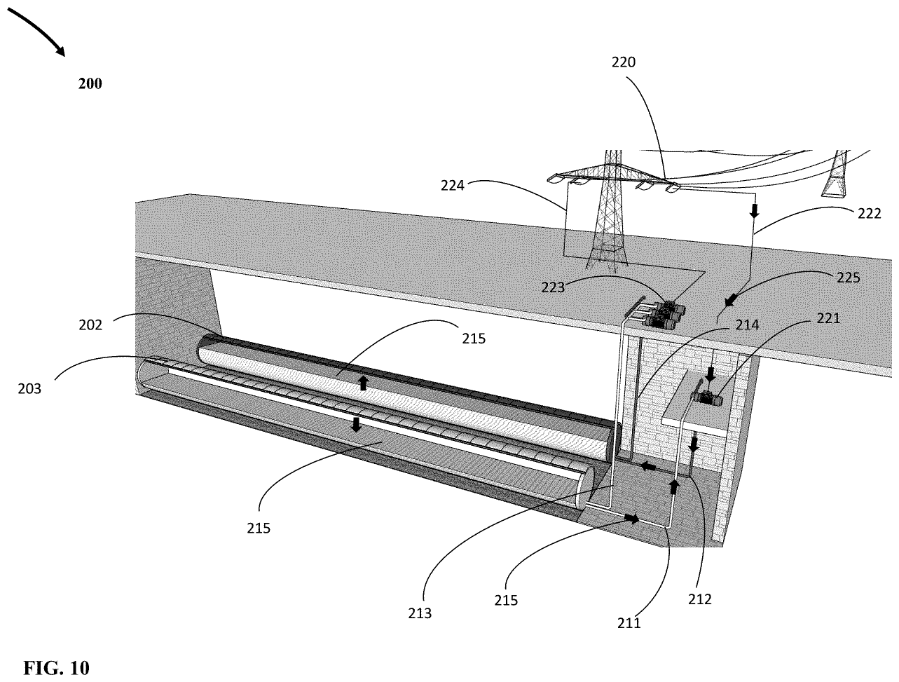

FIG. 10 is a cut profile section of the low-pressure tunnel 203 and high-pressure tunnel 202 of embodiment of the present invention 200 in FIG. 9 during energy storage. Arrows show the flow direction of water 215 and electrical power 225. Water pump 221 receives electrical power 225 from electrical grid 220 via conduit 221 to pump water 215 from low-pressure tunnel 203 via low-pressure water conduit 211 to high-pressure tunnel 202 via high-pressure water conduit 212. This results in a decrease in the volume of air stored in high-pressure tunnel 202 and increase in internal pressure, which stores energy.

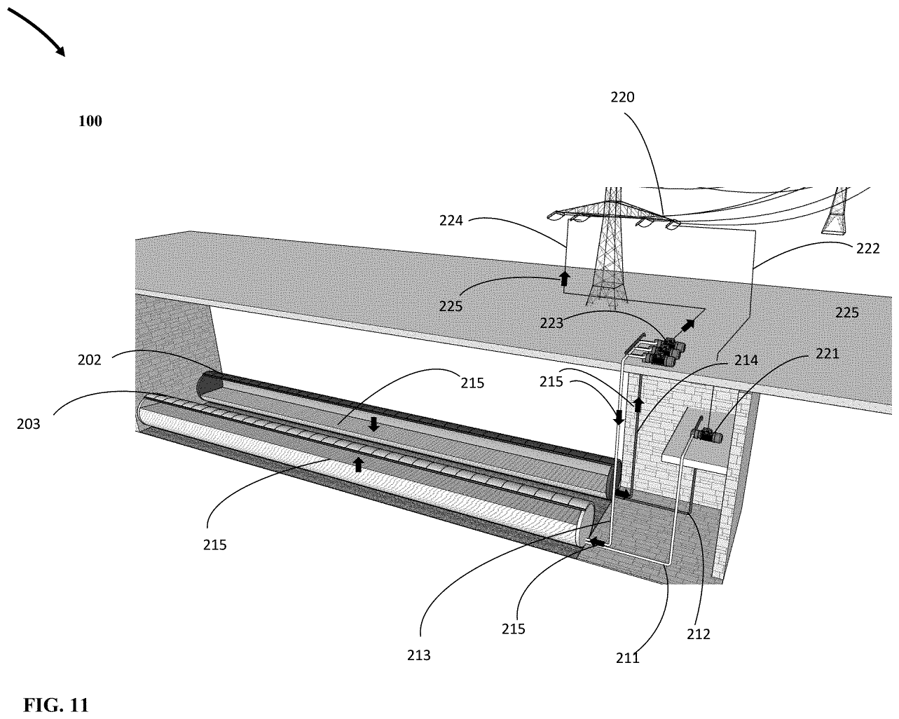

FIG. 11 is a cut profile section of the low-pressure tunnel 203 and high-pressure tunnel 202 of embodiment of the present invention 200 in FIG. 9 during energy recovery. Arrows show the flow direction of water 215 and electrical power 225. Water 215 from high-pressure tunnel 202 flows via high pressure conduit 214 to drive hydraulic generators 213, which supply electrical power 225 to electrical grid 220 via electrical conduit 224. Having driven electrical generators 213, water 215 flows to low-pressure tunnel 203 via low-pressure water conduit 213, which results in an increase in volume of water 215 in low-pressure tunnel 203 and corresponding decrease in volume of air in low-pressure tunnel 203. The latter increases the air pressure in low-pressure tunnel 203. The minimum pressure in the low-pressure tunnel 203 corresponds to the lowest level of water 215 and is set to a value just high enough to provide water pump 221 with adequate back-pressure corresponding to its elevation. This pressure is several orders of magnitude less than the operating pressure of the high-pressure tunnel 202.

The present invention is susceptible to modifications and variations which may be introduced thereto without departing from the inventive concepts and the object of the invention. Configurations other than those described may be used to construct the compressed gas tunnel of the present invention. Also, the term belowground implies confinement by geologic formation and includes tunnels located in mounds, such as mountains and hills, which may be at higher elevation that the surrounding ground. Such modifications and variations do not depart from the inventive concepts and the object of the present invention.

While the present invention has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An apparatus for storing large quantities of compressed gas at high pressure underground, the apparatus comprising:
at least one tunnel bored underground and structurally configured to safely balance internal forces arising from raised internal pressure of said tunnel with external forces from the confining geological formations, said tunnel having perimeter and terminus fully sealed and plugged to prevent escape of pressurized gas contained within,
at least one conduit disposed to establish pneumatic communication between said tunnel and external mechanical equipment disposed to increase and decrease internal pressure of said tunnel by causing inflow and outflow of gas into and out of said tunnel in a controlled manner.

2. An apparatus for storing large quantities of compressed gas at high pressure underground, the apparatus comprising:
at least one tunnel bored underground and structurally configured to safely balance internal forces arising from raised internal pressure of said tunnel with external forces from the confining geological formations, said tunnel having perimeter and terminus fully sealed and plugged to prevent escape of pressurized gas contained within,
at least one conduit disposed to establish hydraulic communication between said tunnel and external mechanical equipment disposed to increase and decrease internal pressure of said tunnel by causing inflow and outflow of liquid into and out of said tunnel in a controlled manner.
